(19) United States
(12) Patent Application Publication
(10) Pub. No.: US 2005/0013899 A1
(43) Pub. Date: Jan. 20, 2005

(54) Cold canine treats

(76) Inventors: Gary Kostlan, Saline, MI (US); Daniel R. Kastor, Hinckley, OH (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/841,068

(22) Filed: May 7, 2004

Related U.S. Application Data
(60) Provisional application No. 60/487,025, filed on Jul. 14, 2003.
(60) Provisional application No. 60/515,745, filed on Oct. 30, 2003.

(51) Int. Cl. A01K 1/00

(52) U.S. Cl. 426/2

(57) ABSTRACT

A pet treat comprises a frozen mixture, the frozen mixture including protein, water, and a therapeutic substance such as glucosamine and/or chondroitin. The frozen mixture can be homogenized and further include entrained air bubbles, and optionally may have a meat flavor such as beef, chicken, lamb, or pork. A support structure, such as a stick, cone, push-up tube, or cup, can be provided to facilitate provision of the pet treat to the pet.

### REFERENCE TO RELATED APPLICATIONS

This application claims priority from U.S. provisional application Ser. Nos. 60/487,025, filed Jul. 14, 2003, and 60/515,745, filed Oct. 30, 2003, the entire content of both of which are incorporated herein by reference.

### FIELD OF THE INVENTION

The invention relates to consumable products, in particular, to pet treats including a frozen mixture.

### BACKGROUND OF THE INVENTION

Frozen mixtures can be especially appealing to pets, particularly dogs. U.S. Pat. No. 4,218,482 to Cook et al. describes a frozen, nutritious pet treat, which may contain vitamins. However, this application does not disclose the use of a frozen mixture to administer anti-arthritic substances to the dog.

In U.S. Pat. No. 5,922,692, Marino describes a process of producing a dried pet food component including forming, freezing, slicing, and drying steps. This process was used to produce a dried powder, not a frozen dog treat. Similarly, U.S. Pat. No. 4,738,864 describes, for example, forming a frozen mixture into a bone shape, followed by rapid heating to heat set an edible product, and does not teach production of a frozen dog treat.

In U.S. Pat. No. 5,364,845, Henderson illustrates health improvements in dogs through administration of capsules including glucosamine, chondroitin sulfate, and manganese ascorbate. However, as a practical matter, it can be difficult to force a dog or other pet to take a capsule.

Other examples of canine health improvements are described in U.S. Pat. No. 6,346,519 to Petrus and U.S. Pat. No. 6,524,609 to Myers, and European Patent EP 0178602B1 to Meisner. For example, Myers describes biscuits having dietary supplements. However, these applications fail to disclose the use of frozen treats to administer dietary supplements to a pet.

In U.S. Pat. No. 6,228,418, Gluck et al. describe vegetarian dog treats including nutraceuticals such as St. John's wort. The treats are baked or fried, not frozen as in embodiments of the present invention.

U.S. Pat. No. 4,840,813 to Greenberg et al. and U.S. Pat. No. 5,456,936 to Toonen describe methods of manufacturing conventional human ice cream, and provide a background to conventional human ice cream manufacturing methods.

U.S. Pat. No. 6,231,901 to Sharkasi et al. describes a variegated frozen confection for humans, but does not describe pet treats or the use of frozen products to administer therapeutic substances to an animal.

Patents referred to within this specification are incorporated herein by reference. U.S. provisional application Ser. Nos. 60/487,025, filed Jul. 14, 2003, and 60/515,745, filed Oct. 30, 2003, are incorporated herein by reference.

### SUMMARY OF THE INVENTION

A pet treat including a frozen mixture facilitates the administration of therapeutic substances, such as anti-arthritic substances, to pets, in particular to dogs. The frozen mixture can include water, fat, protein, carbohydrates, vitamins, minerals, other nutrients for dietary balance, and therapeutic agents. The frozen mixture may have a particulate topping, which may serve decorative, nutritional, or therapeutic purposes. Pet treats can take the form of an ice cream novelty, for example as a within a cup or cone, or as a quiescently frozen mixture similar in nature to an ice cream stick novelty. The support structure (in this case, a stick) is preferably not wooden, as this presents a choking hazard to a pet, but instead formed from a material consumable or safely chewable by the pet. Examples include elongated support structures formed from rawhide or dog biscuit material, such as a chopped rawhide stick or meat-flavored dog biscuit.

A further embodiment of the present invention has a variegated appearance, having two or more visually distinct components. A pet treat may comprise one or more flavored components, and may be nutritious, for example containing vitamins, minerals, and glucosamine, an agent associated with improving or maintaining healthy joint tissue. A flavored variegate can be incorporated into a semi-frozen base material at the time of dispensing into a container, in such a way as to maintain variegate identity throughout the freezing process. The pet treat may also be in the form of a multilayer or sandwich structure.

A pet owner will receive an increased feeling of reward and value for money by providing the pet with a visually attractive pet treat. Improving the appearance to humans of a pet treat increases the likelihood that the pet treat is purchased and provided to the pet. If the pet treat contains an ingredient beneficial to the pet, the pet's health will improve as a result of the enhanced visual appeal to the human purchaser.

### BRIEF DESCRIPTION OF THE DRAWINGS

FIG. 1 shows a pet treat including a frozen mixture contained in a cup;

FIG. 2 shows a top view of a pet treat including a frozen mixture contained in a cup;

FIG. 3 shows a pet treat having a topping;

FIG. 4 shows a pet treat in which a frozen mixture has an embedded stick and coating;

FIG. 5 shows a pet treat having a frozen mixture in a sandwich structure;

FIG. 6 shows a pet treat having a push-up structure;

FIG. 7 shows a pet treat having a cone and variegate core; and

FIG. 8 shows a pet treat within a transparent cup.

### DETAILED DESCRIPTION OF THE INVENTION

Embodiments of the present invention include pet treats comprising a frozen mixture including water, protein, carbohydrates, fat, and fiber. A frozen mixture can be manufactured by preparing a dry base powder comprising a protein, fat, carbohydrates, fiber, and micronutrients (such as vitamins and minerals), and a therapeutic substance such as glucosamine. A pet treat according to the present invention may include a frozen mixture produced using the methods described in U.S. Pat. No. 4,218,482 to Cook et al. with additional components or other aspects as described herein.

A frozen mixture may include a high protein component, animal fat component, vitamins, minerals, and an anti-arthritic compound. For example, a frozen mixture may be a homogeneous mixture containing approximately 65% water, 7% lipid, and 8.8% crude protein (by weight). Prior to freezing, air may be entrained within the frozen mixture and the mixture homogenized.

Protein sources which may be used include animal products (such as beef, pork, lamb, chicken, organ meats such as liver), fish, yeast, milk proteins such as caseinates, other dairy products such as cheese or yogurt, whey, soy, or other plant sources. Dogs have trouble digesting lactose, and frozen mixtures intended for dogs preferably include less than 1.0% lactose. For dog treats, it is preferred that lactose be removed or reduced to less than 1%, for example 0.5%, 0.1%, 0.05%, or less.

The pet treat may provide similar nutritional properties to conventional pet food. In one example, a blended powder was used where the approximate crude protein was 25%, the approximate crude lipid content was 20%, crude fiber was approximately 0.90%, and glucosamine was approximately 0.05% of the base powder.

In other versions, a frozen mixture may be a homogeneous mixture including approximately 30% water, 35% entrained air bubbles and 35% of base powder supplying a high protein component, animal fat component, vitamins, minerals and an anti-arthritic substance such as glucosamine. Preferably, the powder contains less than 1.0% lactose.

An improved frozen mixture for use in a dog treat was prepared from a dry powder, the powder composition by weight being approximately 25% crude protein, 20% crude fat, 0.9% crude fiber, 0.51% lactose, 0.16% calcium, 0.26% phosphorus, 0.03% sodium, 0.09% magnesium, 0.76% potassium, 0.49 ppm copper, 32.12% iron, 10.29% manganese, 16.61 ppm zinc, 1.94% lysine, 0.4% methionine, and 0.05% glucosamine. The powder included soy flour, which was heat treated to reduce an allergic response for some puppies. The protein source can include whey from which lactose has been removed. This formulation may be processed by conventional ice cream making equipment.

As another example, a frozen mixture can be formed from a blended powder including soy flour, a high fat source (such as animal fat), whey protein concentrate, vitamin E, a vitamin and mineral base including other vitamins and minerals, corn syrup solids, and corn oil. The resulting frozen mixture may be off-white, due to heat treatment of the soy flour to remove puppy allergens. Rice flour can be substituted for soy flour so as to obtain a whiter appearance, though rice flour may be more expensive. For example, the ratio of soy flour to rice flour can be adjusted (e.g. a soy:rice ratio of 40:60) to obtain an acceptable level of whiteness at an acceptable cost. Whiteners can also be added, as described in more detail below.

A variegate can be formed from corn syrup, water, maltodextrin, modified corn starch, caramel color, flavor, potassium sorbate, and citric acid, and rippled or swirled through a frozen mixture. The variegate flavor can be meat flavor, such as beef, pork, lamb, or chicken, and can resemble gravy or a sauce in viscosity and color. The variegate can also be a second frozen mixture, having a visually distinct appearance from a first frozen mixture.

A pet treat according to the present invention can be also formed by an extrusion process. For example, an extrusion process can include the steps of freezing a mixture so that approximately 80% is frozen as it is extruded through a tube, supporting the resulting near-plastic (or semi-solid) product on a plate, after hot wire slicing the product, optionally inserting a stick or handle, freezing the product completely in a freezing tunnel, supporting the treat by the stick or otherwise supporting the treat, enrobing the product, and wrapping the resulting pet treat. The pet treat can be formed by an extrusion process into a shape of choice, for example a bone, paw, other animal part, or other shape. For example, the enrobing process can be used to coat the pet treat with a carob-flavored coating that hardens on contact with the frozen mixture. The stick may be pet-edible, for example a dog chew such as a product including rawhide. The stick may also be an elongated biscuit, other baked material or similar (such as a meat basted dog biscuit), flavor enhanced polymer stick (such as a flavor enhanced nylon product, such as a NYLABONE made by Nylabone Products of Neptune City, N.J.), polymer (such as nylon or polyurethane), or other pet edible or chewable product, for example products formed from cereals (such as corn or rice), products derived from potato, starch, other polysaccharides, or the like, or may be a rubbery material which may be safely chewed by the pet. The stick may also act to clean the teeth of the pet, or to freshen breath.

A pet treat can also be formed as a quiescently frozen product. The pet may be formed by a method including freezing the mixture approximately 30% to form a slush, pouring into a mold, freezing completely over a period of time (such as 20 minutes), inserting a stick, melting an outer surface, extracting, enrobing, and wrapping.

Pet treats may be packaged with a support structure such as a cup, cone, push-up devices, stick, wafer, sandwich structure, or as a bar or coated bars, or in other forms. The support structure can be edible or chewable by the pet, as discussed in more detail below. Pet treats may be in the forms of scoops, swirled combinations of visually distinct components, multilayer forms, coated forms, covered in a viscous liquid such as a gravy or sauce (viscous in this context indicating a viscosity noticeably greater than water), covered in particles, or otherwise presented. These aspects will be discussed in more detail below.

In this specification, the term frozen mixture refers to a mixture which is intended to be served to a pet at a reduced temperature. This includes products which may be sold at room temperature for subsequent freezing or refrigeration by a pet owner before being served to a pet. The term frozen mixture may refer to an ice-cream like product, quiescently frozen product, frozen yogurt, ice, slush, sorbet-like product, frozen custard, gel, soft-serve product, or the like. Pet treats including a frozen mixture may additionally include other consumable components, such as decorations, coatings, sauces (such as oils, gravy, and other viscous liquids), wafers, biscuits, sticks, and the like. The pet treat may also include non-edible materials, for example for convenience of handling or storage, such as a lid on a cup.

The appearance of a pet treat can be dramatically improved by introducing one or more visually distinct variegate components. For example, the pleasing appearance of a sundae can be obtained. Food colorings may be added to one or more components of a pet treat to enhance appearance, for example caramel, annatto, whiteners such as titanium dioxide, or other colorings such as FDA-approved colorings for human foods, which are well known in the art, other dyes, brighteners (such as fluorophores), and the like. A variegate component can be a meat flavored sauce rippled or swirled through a frozen mixture, or coating the frozen mixture in whole or in part.

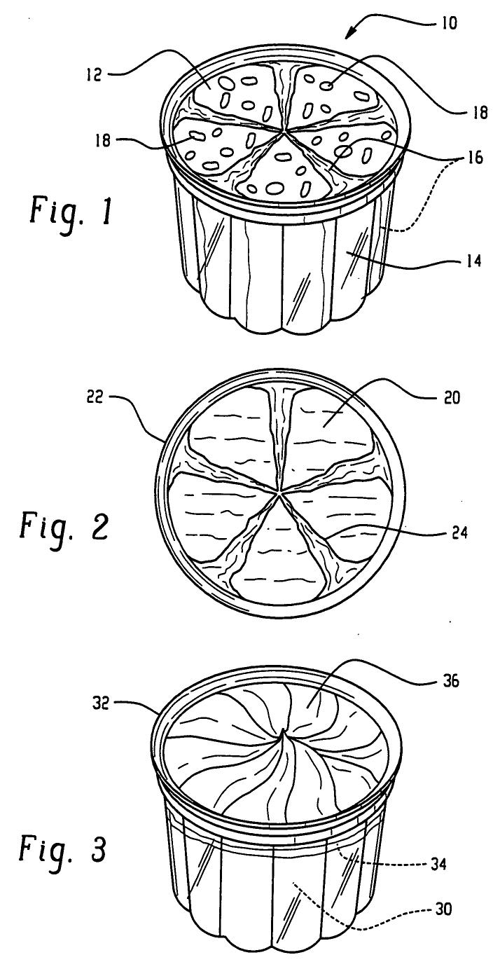

FIG. 1 illustrates, in cross section, a pet treat shown generally at 10, including a frozen mixture 12 contained within a transparent cup 14. The pet treat also includes a variegate component 16, visually distinct from the frozen mixture 12, swirled together with the frozen mixture so as to provide a visually pleasing appearance to a human. A surface of the frozen mixture 12 supports a number of decorations 18. The decorations may include biscuit pieces, rawhide, carob pieces, or other decorations discussed in more detail below. In other embodiments, decorations may be included within the frozen mixture. The variegate component can be a meat flavored sauce.

A pet treat may include two, three, four, five, or more, visually distinguishable components swirled or rippled together. One or more of the components may contain a therapeutic substance, such as an anti-arthritic substance, for example glucosamine. One or more of the components may contain flavoring, such as a meat flavor (for example, beef, lamb, pork, chicken, liver, and the like), or carob flavor.

For example, a pet treat can comprise a first component having a first color, and a variegate component having a second color visually distinct from the first color. In one example, the first component is a frozen mixture such as those described elsewhere in this specification. The variegate component may also comprise a frozen mixture, for example a frozen mixture having a different flavor and color from the frozen mixture. In other embodiments, the variegate component may not be frozen, for example comprising a viscous liquid (such as syrup, sauce, or gravy), or gel. A rippled or swirled appearance can be achieved. In some embodiments, the variegate may be oil based, for example to facilitate administration of hydrophobic therapeutic substances or vitamins (such as Vitamin E), to provide nutritional balance, or to provide a desired texture or flavor profile.

For example, the first component may have a meat flavor, and the variegate component may be carob flavored, meat flavored, or unflavored. A variety of flavor profiles can be obtained, such as beef/carob, chicken/pork, lamb/chicken, liver/beef, or other combination.

A flavored variegate component can be incorporated into a semi-frozen first component at the time of dispensing into a container in such a way as to maintain variegate identity throughout the freezing process. A decorative topping can also be dispensed onto the top of the frozen mixture or included within the frozen mixture at the time of filling the container. For example, a vibratory feed can be used to sprinkle decorations over a surface of the frozen mixture, such as crushed biscuit, rawhide pieces, dog bone shaped pieces, kibble, carob, nuts (such as peanuts), and the like. Decorations can also include circular, dog-bone, paw-shaped, animal shape, other animal part shape, or other shaped pieces. Such decorations can also be added to the frozen mixture as inclusions.

A flavored variegate component can be incorporated into the product at the time the container is filled before completion of the freezing process. The incorporation can be conducted in such a way to maintain identity of the variegate component. The variegate can be a contrasting color to the frozen mixture manufactured from a base powder. The pattern can be injected into the partially frozen mixture in a way to appear as a swirled or striped ribbon. Various single flavors or a combination may be used in manufacturing the product. Alternatively, different visually components can be dispensed sequentially into a container.

FIG. 2 illustrates, in a top view, a pet treat having a frozen mixture 20 contained within a cup 22. A variegate component 24 is swirled through the frozen mixture.

FIG. 3 illustrates a pet treat having a frozen mixture 30 disposed within a transparent cup 32, a surface of the frozen mixture being covered with a coating 34. The surface of the coating supports a white foam 36, to simulate the appearance of cream. Other cream-like materials can be used. The foam can be a conventional synthetic whipped cream or other material. The coating can be in the form of a hard shell or a sauce. Sauce or other coating can also be located above or mixed with a cream layer.

In other embodiments, a pet treat may comprise a frozen mixture covered with a coating, so as to make the treat easy to handle by a human. For example, the pet treat may comprise a frozen mixture, having a coating, which is solid at room temperature. The coating may be oil based, for example a waxy substance. Confectioners' coatings for human foods are well known in the art, and may be adapted for use in pet treats. For dogs, carob-containing coatings may be used in place of chocolate coatings. The coating may contain embedded decorations, and may be flavored (for example, meat, or carob flavor).

Packaging

Forms of packaging will now be discussed in more detail. A pet treat may be packaged in a cup, for example having a removable cover to help prevent degradation, removable before providing the pet treat to the pet. Cups may be formed from plastic, and discarded, re-used, or recycled after use.

Rigid pet-edible materials may be used to form components of a pet treat, for example a cup, stick, sandwich structures (such as a wafer), tube, dish, plate, coating, or other component. Rigid pet-edible materials include biscuits or wafer like materials, (such as cereal based products, including rice based products), rawhide (such as pressed chopped rawhide products), edible polymers, dried meat, other animal products, and the like, and may be a rubbery or resilient material, other digestible animal food substance, or chewable material.

Safely chewable materials can also be used to form components of a pet treat. Safely chewable materials include synthetic rubber, nylon, polysaccharides, gums, other polymers, and other materials. Components of a pet treat, if not eaten, can be reused for treats given to the same pet.

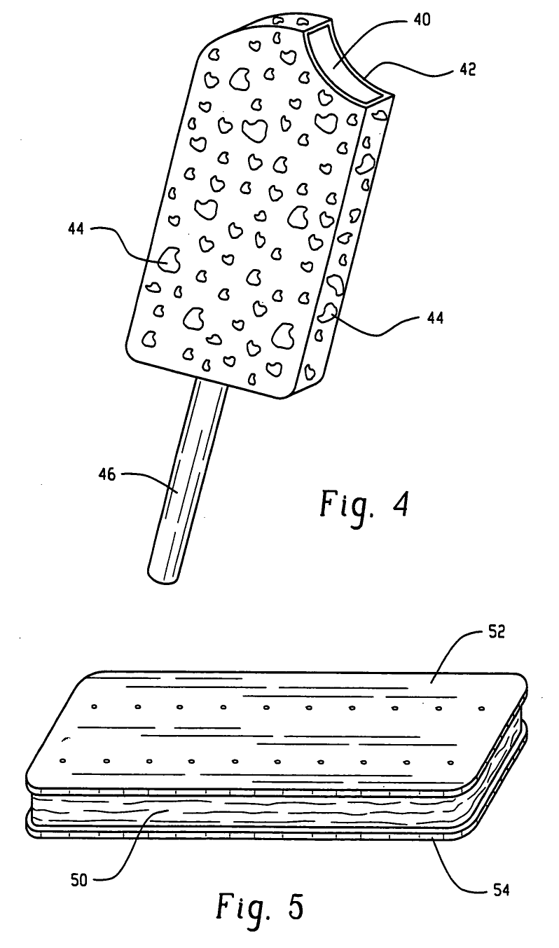

FIG. 4 illustrates a pet treat including a frozen mixture 40, coating 42, decorations 44, and support structure in the form of a stick 46. Wooden sticks can be hazardous to dogs. For a dog treat, the stick can be an elongated dog chew or dog biscuit embedded in the frozen mixture. The dog chew may include rawhide or other animal product, NYLABONE, or may be rubbery or otherwise safely chewable. The coating or decorations can be omitted.

A person can hold the stick to support the frozen mixture close to a pet to allow the pet to lick the treat. The stick may be formed of wood or polymer, as in a conventional human stick-based ice cream. However, wood is a choking and gastrointestinal hazard for dogs. The stick may be formed from one or more pet-edible materials, such as rawhide or biscuit, to reduce the choking hazard associated with chewing wooden sticks. The stick may also be formed from one or more safely chewable materials. For example, a safely chewable rubber or rawhide stick presents a reduced choking hazard, and adds to the enjoyment of the pet, and hence the reward to the owner on providing the treat to the pet. The pet treat may have a further outer covering, such as a plastic or paper film, removable by the pet owner before providing the treat to the pet.

FIG. 5 shows, in cross section, a pet treat including frozen mixture 50 sandwiched between two rigid planar pieces 52 and 54. The two pieces may be formed from a rigid pet-edible material. The pet treat may also be formed as an open sandwich, having a single rigid piece supporting the frozen mixture. The rigid piece may be flat or dish-shaped. The rigid piece may be a dog chew, for example a piece of rawhide or other safely chewable material, a biscuit, wafer, or other material. In other embodiments, the frozen mixture may contain a variegate component or include decorations.

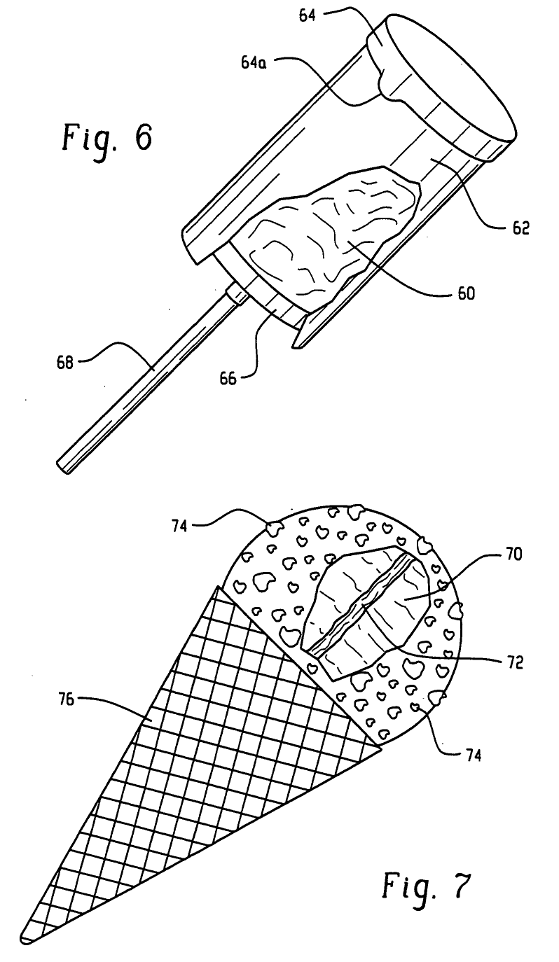

FIG. 6 shows, in cross section, a pet treat in the form of a push-up device including frozen mixture 60, generally cylindrical tube 62, sealing film 64 having tab 64a, pusher 66, and handle 68. The pet owner removes the sealing film 64, and uses the handle 68, which operates in cooperation with the pusher 66, to push the frozen mixture at least partially out of the tube 62 so as to be lickable by the pet.

The tube, pusher, and handle may be formed from plastic, cardboard, or other suitable material. The tube may further include a thermal insulation material, such as foam. The handle may be in the form of a dog chew, such as a rawhide stick or other safely chewable material.

FIG. 7 shows a pet treat having a frozen mixture 70, variegate core 72, surface decorations 74, and cone holder 76. The variegate core can be a sauce or syrup. The cone holder can be formed from a material edible by the pet, such as rawhide, biscuit, or other material.

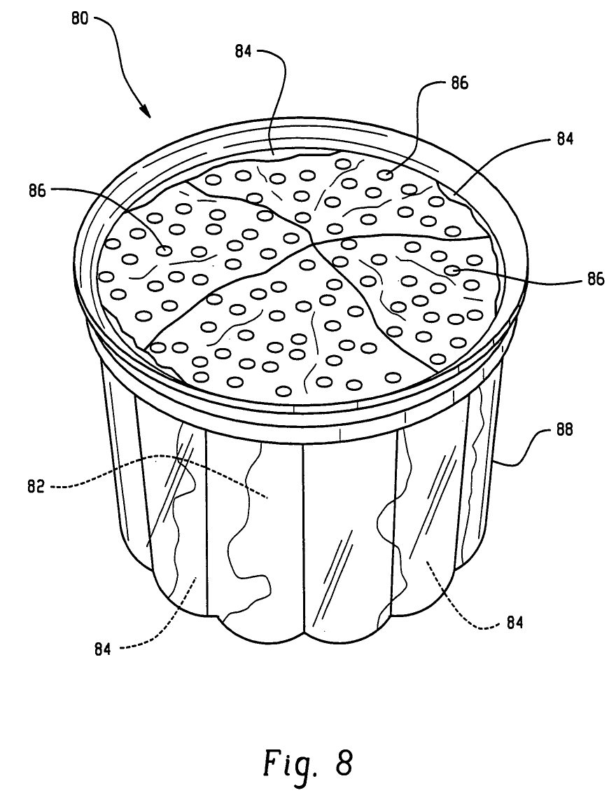

FIG. 8 shows a pet treat 80 manufactured according to the present invention, intended for a dog. The treat includes a frozen white base material 82, a brown variegate 84 swirled through the base material, and colored decorations 86 sprinkled on the exposed top surface. The treat is contained within a translucent plastic cup 88. The decorations are yellow, orange, red, green, and blue, which provides a pleasing appearance, though of course other color combinations or a single color can be used. The pet treat looks similar to a human sundae cup, however it contains reduced (or no) lactose (milk sugar) and is specially formulated as a nutritionally balanced and readily digestible, premium dog treat. The treat is fortified with vitamins and minerals, added to the base material, and the base material also contains glucosamine to promote healthy canine joints. The treat can be manufactured in a conventional ice cream factory using standard ice cream pasteurizing, freezing and filling equipment, can be distributed at 0° F., and can have a one year or more (frozen) shelf-life.

The white base material can be formed from a mixture including soy flour, maltodextrin or dextrose, substantially lactose free whey protein concentrate, corn syrup, corn oil, a high fat source (animal fat), a vitamin/mineral package, titanium dioxide, and glucosamine. For puppies, soy flour is heat treated to remove an allergenic component. The soy flour can optionally be bleached. The addition of titanium dioxide provides significant whitening to improve the appearance of the product. The brown visually distinct variegate swirled within the white base mixture includes beef, corn syrup, dextrose and/or maltodextrin, caramel color, modified corn starch, flavors (such as chicken or beef), potassium sorbate, and citric acid. The variegate has the form of a thick (viscous) sauce.

Stabilizers can be optionally added to the base material to reduce formation of ice crystals. Texture enhancers, such as oils, are also optional. However, dogs do not seem concerned over small degrees of crystallization. The base material may have a whitened portion near an exposed surface to improve appearance, the remainder being off-white. Whiteners other than titanium dioxide can also be used.

A pet treat (such as a pet treat including a quiescently frozen mixture) may be packaged in a tube. For example, a consumer may be supplied with a container, for example in the form of a sealed tube, containing a frozen material, the frozen material comprising, for example, a flavor (such as a meat flavor), a therapeutic substance such as an anti-arthritic substance, one or more vitamins, and one or more minerals. The frozen material may contain soluble protein, dispersed fats, fiber, or other components. One end of the tube can be opened or removed, and the frozen mixture pushed out so as to be consumable by the pet. The pet treat can be sold at room temperature, and liquid components can be frozen by the consumer before provision to the pet.

A pet treat can also be formed as a coated bar. For example an internal frozen white material, containing an anti-arthritic substance, can be coated with a carob-flavor coating.

Frozen mixture may be packaged in a container, and scooped out or otherwise dispensed by the pet owner to provide a pet treat for a pet. The frozen mixture forming the pet treat and suitable containers (such as cups, dishes, or cones) may be supplied separately. For example, cups may be stored outside of a freezer, and manually filled with frozen mixture scooped or otherwise removed from a bulk package by the pet owner. A machine may be used to dispense a measured quantity of frozen mixture into a container. The measured quantity may be correlated with a desired biologically significant quantity of a therapeutic substance, possible determined in relationship to the weight of the pet, or determined from nutritional balance considerations.

In any form of packaging, the frozen mixture may be variegated, and may contain or support decorations, a viscous liquid (such as sauce or gravy like material, emulsion, or other flavored or visually distinct liquid) and/or whipped cream like material, for example a foam. The pet treat may also have a drumstick, bone, animal (such as a dog or cat), or other external shape.

Therapeutic Substances and Micronutrients

An improved pet treat may also contain one or more therapeutic substances. As the term is used in this application, a therapeutic substance may be an anti-arthritic substance (discussed below), analgesic, antibiotic, anti-microbial agent, pharmaceutical, amino acid, nutraceutical, or other compound beneficial to the health of the pet.

Therapeutic substances may be beneficial against one or more ailment or potential ailment, such as arthritis, hip dysplasia, gum disease (such as periodontal disease), metabolic disorders, pain, inflammation, bacterial infections, fungal infections, digestive disorders, flatulence, or other ailment or combination of ailments.

The term anti-arthritic substance will be used here to generally to describe a substance which can be a useful in helping to prevent, reduce, or slow the development of connective tissue disorders such as (but not limited to) arthritis, or to reduce joint pain or stiffness through any mechanism. As used here, anti-arthritic substances include anti-inflammatory agents, for example as discussed in U.S. Pat. No. 6,346,519 to Petrus.

Anti-arthritic substances include, but are not limited to: amino sugars (such as glucosamine, mannosamine, galactosamine, and related compounds such as analogs and derivatives), amino acids (such as cysteine, tyrosine, or other amino acids), other glycosaminoglycans, heparinoids, glucaronic acid, piroxicam, tetracyclines, steroids such as corticosteroids, chondroitin, hyaluronic acid, cetyl myristoleate, antioxidants, anti-inflammatories, tyrosine, phenylaniline, essential fatty acids such as omega fatty acids such as Ω-6 fatty acids, nitric oxide synthase inhibitors, other anti-arthritic substances known in the art, or derivatives, precursors, or analogs thereof.

Vitamins such as Vitamin C (ascorbic acid and other ascorbates such as sodium ascorbate or manganese ascorbate) and Vitamin E have been attributed with anti-arthritic properties. Minerals such as zinc (for example in the form of zinc acetate, zinc chloride, zinc sulfate, or other zinc compounds discussed in U.S. Pat. No. 6,346,519 to Petrus) and copper have also been attributed with anti-arthritic properties.

As used here, the term glucosamine includes various glucosamine salts, such as chloride, hydrochloride, sulfate, phosphate, other biocompatible glucosamine salts, and glucosamine derivatives. Glucosamine derivatives include N-acetyl glucosamine and N-acetyl galactosamine, and 2-glucosamine derivatives such as N-acylated 2-glucosamine (for example, as described in U.S. Pat. No. 6,479,469 to Anastassiades), glucosamine oligomers, and the like. The anti-inflammatory action of glucosamine can be speeded up by addition of a proteolytic enzyme, for example as described in U.S. Pat. No. 5,679,344 to Williams et al., and such enzymes can also be provided within a frozen pet treat. As used here, the term chondroitin includes chondroitin salts such as chondroitin sulfate.

Anti-arthritic substances also include natural products such as dried shellfish digest (present in Natures Recipe™ Joint and Hip Treats for Dogs), which contains glucosamine and chondroitin. Other anti-arthritic natural products include shark cartilage, other cartilage products, vertebrate connective tissue, canola oil, other biological extracts, and the like.

Analgesics include aspirin, ibuprofen, fenoprofen calcium, tolmetin sodium, indomethacin, piroxicam, naproxen, and sulindac. Certain analgesics are also anti-inflammatory, and so constitute anti-arthritic substances. For example, in EP 0178602B1, a dog having advanced arthritis was provided with a single aspirin per day. Improved frozen dog treats according to the present invention may further comprise one or more analgesics such as aspirin. The choice and dose of analgesic, if any, will be made with reference to the species and weight of pet.

As will be evident to those skilled in the art, a micronutrient (such as a vitamin or a mineral) may also act as a therapeutic substance. The pet treat may include one or more micronutrients (such as vitamins or minerals), for example included to correct a dietary imbalance such as a vitamin or mineral deficiency in the pet. Pet treats can be used to provide therapeutic substances to the pet, for example as perceived by the pet owner or on a recommendation by a veterinary professional.

Vitamins, which may be present in the pet treat include vitamins A, C, D, E, K, thiamine, riboflavin, niacin, vitamin B6, folate (such as folic acid), vitamin B12, biotin, and pantothenic acid, or equivalents (such as salts of acids, derivatives, or analogs). Added minerals may include the elements boron, calcium, copper, chromium, cobalt, iodine (for example, as iodide), iron, magnesium, manganese, molybdenum, selenium, phosphorus (for example, as phosphate), selenium, and zinc. Minerals may be present in any acceptable form or compound. For example, the pet treat may include carbonates, chlorides, iodides, oxides, phosphates, sulfates, and other salts.

Amino acids include alanine, cysteine, creatine, creatinine, glycine, phenylanaline, tyrosine, tryptophan (which may act to calm certain animals), valine, alanine, glutamine, taurine (a heart therapeutic), aspartic acid, S-methylcysteine, other amino acids known in the art, and their synthetic analogs and derivatives.

Nutraceuticals may also be included, for example St John's wort, ginseng, green tea, ginger, garlic, vincamine, vinpocetine, aloe vera, gingko biloba, other botanical extracts, and the like. The proportion of these and other ingredients within a frozen dog treat can be chosen from ranges, compositions, and dosages known in the art in relation to other products, such as the fried consumables described in U.S. Pat. No. 6,228,418 to Gluck, the compositions of U.S. Pat. No. 5,346,845 to Henderson, U.S. Pat. No. 4,647,453 to Meisner, and within other art. Compositions and portion sizes may be adjusted according to the species, mass, and breed of the pet. Other substances may also be present, such as activated charcoal. Therapeutic substances may be encapsulated, for example as coated particles, to enhance palatability of the pet treat.

Pharmaceuticals may also be included, for example to cure diseases of the pet or otherwise alleviate symptoms. The pet treat may include ingredients to prevent or help avoid afflictions such as bordatella, tick-borne diseases such as Lyme disease, fleas, intestinal parasites such as worms, or other afflictions. Ingredients may also be included to facilitate weight loss, for example non-digestible fiber.

Decorations and Flavors

The frozen mixture may have one or more surfaces, which support decorations. Decorations may include particulate matter, chips, sprinkle, nuts, colored films, confectioner's confetti, and the like. Pet treats for dogs may include decorations in the form of dog biscuit particles, kibble, dog bone shaped pieces, and rawhide chips. Decorations may be meat flavored or otherwise flavored, and may contain one or more therapeutic agents, as discussed in more detail below.

For example, the exposed surface of a frozen mixture contained within a cup may support one or more decorations. For example, the surface may support rawhide chips, simulated bacon pieces, other savory particles, crunchy pieces such as dog biscuit fragments, and the like.

Decorations may be formed from animal products (such as dried animal products such as dried liver or rawhide), plant products (such as cereal or soy), baked products such as dog biscuit fragments, or some combination of products. Decorations may be flavored in the same way as the frozen mixture, or have a different flavor.

Decorations may be dispersed throughout the frozen mixture as inclusions, for example to add flavor or texture, and may contain therapeutic substances, such as anti-arthritic compounds, such as glucosamine. A component resembling cream, such as a foam, may cover some or all of an exposed surface of the frozen mixture for ornamental effect. A combination of a sauce (such as a meat flavored gravy) and a foam can enhance the sundae-like appearance of a pet treat. Decorations may be added to the pet treat just prior to packaging, may be packaged separately for sprinkling over a pet treat, and may be mixed in with the frozen mixture.

Flavors used in a pet treat (within a frozen mixture, variegate, or other component) may include a meat flavor (such as beef, chicken, lamb, and pork; the term meat flavor also including organ flavor such as liver and lung), plant-derived flavor (such as carob, peanut butter, vanilla, mint, and the like), dairy flavor (such as cheese, butter), and other natural and/or synthetic flavors, such as smoky flavor or bubble-gum flavor. Chocolate is well known to be toxic to dogs, and carob can be used as a non-toxic plant-derived flavor alternative. Flavors can be applied as coatings to any part of the treat, for example as a basted coating to a biscuit stick.

Meat flavors will generally be attractive to carnivorous pets, such as dogs and cats. Vegetarian pets, such as rabbits, may be more attracted to plant-derived flavors (such as grass, lettuce, or carrot), or to sweeteners. However, such ingredients may also be included in dog treats.

Chocolate is toxic to dogs, but may be included in treats for other animals. For example, a pet treat may comprise a frozen mixture including protein, a therapeutic agent such as an anti-arthritic substance (for example, glucosamine), chocolate, and sugar.

Pet treats may also include sweeteners. Sweeteners include natural sugars (such as sucrose, glucose, and fructose), and sugar substitutes such as aspartame, saccharin, Alitame™, acesulfane K, cyclamates, and sucralose. For example, pet treats may include sweeteners, malt extracts, maltodextrose, and the like. Additives may be included to improve the aroma to humans, regardless of the preference of the animal.

Certain plant-derived flavors may be attractive to pets. For example, catnip flavor added to a pet treat would be attractive to cats.

A flavoring distasteful to people, yet acceptable to a given pet, can be included to make the frozen mixture unattractive for human consumption. Strong meat flavors, such as liver flavor, may be suitable for this purpose.

Other Embodiments

The pet treat may also include one or more salts, such as sodium chloride, potassium chloride, or other salts, to which certain animals may be attracted, or which may act as a therapeutic substance. Herbs and other botanical extracts may also be included, for flavor or for therapeutic purposes.

A pet treat may further include one or more additional components, such as an emulsifying agent, defoaming agent, palatability enhancer, peptizing agent, preservative, anti-microbial agent, antibiotic, viscosity modifier (such as a gum), freezing point modifier, ice formation preventer (such as glycerol), texture modifier, stabilizer, and the like, or some combination of such components. A single ingredient may perform multiple functions.

Emulsifiers include surfactants, such as lecithin, polyoxy-ethylene-glycol, oleates, phospholipids, proteins or esters formed from long chain fatty acids and a polyhydric alcohol, fatty acid esters of glycerol, polyglycerol esters of fatty acids, and sorbitan esters of fatty acids and polyoxyethylene and polyoxypropylene esters of fatty acids; for example as discussed in U.S. Pat. No. 5,456,936 to Toonen.

Certain pets, such as dogs, can be sensitive to lactose, so pet treats may include reduced lactose, for example less than 1% lactose, or less than 0.5% lactose, or pet treats may be substantially lactose-free.

Pet treats may also be quiescently frozen, for example in the form of a stick treat. As discussed above, sticks can be formed from non-wood materials. A quiescently frozen mixture may contain water, flavor, a micronutrient, a therapeutic substance, and additional ingredients as required. Pet treats may also include ice, slush, frozen gel, or frozen yogurt, or a material which is highly viscous or near solid at reduced temperatures.

The above examples illustrate pet treats according to the present invention, including dog treats. The invention is not limited by the examples given, which are intended to be illustrative. Pet treats may be formulated for cats, rabbits, horses, other mammals, or other animals such as such as birds and reptiles.

The frozen mixture may also be produced in conventional bulk ice cream packages including but not limited to pint, quart, half gallon, gallon, multiple quart sizes, or the metric equivalent package. The use of a stabilizing agent is optional depending on the product manufactured. The product can take other ice cream forms such as an ice cream sandwich, tube novelty, styled as a human cake, or provided as bite sized pieces (possibly customized to the bite size of a particular dog size or breed).

A bite sized piece may include a frozen mixture covered with a coating that does not liquefy (or which liquefies slowly) at room temperature or when contacted by a human hand. The coating may be a high-wax material, powdered solid, or other material safely consumable by the pet. The coating may only partially cover the frozen mixture, for example it may be a tube, cup, disk, or other form.

Pet treats may be dispensed from a machine, for example a vending machine. Pet treats may also be dispensed in soft-serve form from a machine (such as are described in U.S. Patent App. Pub. No. 2003/0090958 to Miller et al.). A pet treat may be extruded into a cone, cup, or other structure. The pet treat may be variegated, for example including two frozen mixtures of difference colors, or a frozen mixture and a visually distinct sauce.

Pet treats containing a therapeutic material (such as a pharmaceutical) may be administered to a pet by a vet.

Pet treats described above may be adapted for administering therapeutic substances to humans. Variegated products may be particularly useful in administering therapeutic substances to children, particularly in a controlled environment such as a hospital.

Pet treats may include frozen mixtures which freeze or gel at temperatures above the freezing point of water, for example at or below the temperature of a conventional domestic refrigerator, or freeze-dried products.

The invention is not restricted to the illustrative examples described above. Other examples will be clear to those skilled in the art, including combinations other than the specific examples provided. Elements of specific examples may be omitted, or combined with elements of other examples to provide additional examples. Examples of substances having a particular characteristic are provided for illustration, and are not meant to be limiting or exclusive.

1. A pet treat comprising a frozen mixture, the frozen mixture including protein, water, and a therapeutic substance, the therapeutic substance having a beneficial effect on joint health of the pet.

2. The pet treat of claim 1, wherein the therapeutic substance is glucosamine or chondroitin, or a chemical derivative of glucosamine or chondroitin.

3. The pet treat of claim 1, wherein the therapeutic substance is an anti-inflammatory agent or analgesic.

4. The pet treat of claim 1, wherein the frozen mixture is homogenized and further includes entrained air bubbles.

5. The pet treat of claim 1, wherein the frozen mixture is white and includes titanium dioxide, so as to provide a more pleasing visual appearance to a human owner of a pet.

6. The pet treat of claim 1, wherein the pet treat further includes a variegate component, the variegate component being visually distinct from the frozen mixture.

7. The pet treat of claim 5, wherein the variegate component is a meat flavored sauce.

8. The pet treat of claim 1, wherein the frozen mixture further includes a meat flavor.

9. The pet treat of claim 6, wherein the frozen mixture and the variegate component are interlaced together within a support structure.

10. The pet treat of claim 7, wherein the support structure is a cup.

11. The pet treat of claim 7, wherein an exposed surface of the frozen mixture supports decorations so as to provide a more pleasing visual appearance to a human owner of the pet.

12. The pet treat of claim 9, wherein the decorations are colored particles.

13. The pet treat of claim 1, further comprising a support structure, the support structure facilitating provision of the pet treat to the pet, the support structure being consumable or safely chewable by the pet.

14. The pet treat of claim 10, wherein the support structure is an elongated structure comprising rawhide.

15. The pet treat of claim 1, wherein the frozen mixture is extrudable from a tube.

16. The pet treat of claim 1, wherein the frozen mixture is coated in a high-wax material so as to be conveniently handled by a human owner of the pet.

17. A pet treat, comprising
a frozen mixture including protein, fat, and water; and
a variegate, the variegate being visually distinct from the frozen mixture,
wherein the frozen mixture and variegate are provided so as to be consumed together by a pet when the pet treat is provided to the pet,
and wherein the frozen mixture or the variegate includes a therapeutic substance beneficial to pet health.

18. The pet treat of claim 17, wherein the therapeutic substance has a beneficial effect on joint health of the pet.

19. The pet treat of claim 18, wherein the therapeutic substance is glucosamine or chondroitin, or a derivative of glucosamine or chondroitin.

20. The pet treat of claim 17, wherein the variegate is a viscous liquid.

21. The pet treat of claim 17, wherein the variegate is a second frozen mixture.

22. The pet treat of claim 17, wherein the frozen mixture and the variegate are interlaced together in a cup.

23. The pet treat of claim 17, wherein the frozen mixture or the variegate further includes a meat flavor.

24. The pet treat of claim 18, wherein pet treat further includes particles disposed within or supported by the frozen mixture.

25. A method of administering a therapeutic substance to a pet, the method comprising the provision of a pet treat to the pet, wherein the pet treat includes a frozen mixture, the frozen mixture including protein, water, and the therapeutic substance.

26. The method of claim 25, wherein the therapeutic substance is glucosamine or a derivative of glucosamine.

27. The method of claim 25, wherein the therapeutic substance is chondroitin or a derivative of chondroitin.

28. The method of claim 25, wherein the pet treat further includes a support structure embedded in the frozen mixture, so as to facilitate providing the pet treat to the pet.

29. The method of claim 28, wherein the support structure is an elongated structure including rawhide.

30. The method of claim 28, wherein the support structure is an elongated structure including a flavor enhanced polymer.

31. The method of claim 25, wherein the frozen mixture is contained within a cup.
